(19) United States
(12) Patent Application Publication
(10) Pub. No.: US 2014/0164932 A1
(43) Pub. Date: Jun. 12, 2014

(54) VEHICLE COORDINATING SYSTEM

(71) Applicant: Honda Motor Co., Ltd., Tokyo (JP)

(72) Inventors: Hitomi Takatsudo, Wako-shi (JP); Yuji Yokota, Wako-shi (JP); Junichiro Onaka, Wako-shi (JP)

(73) Assignee: HONDA MOTOR CO., LTD., Tokyo (JP)

(21) Appl. No.: 14/099,568

(22) Filed: Dec. 6, 2013

(30) Foreign Application Priority Data
Dec. 7, 2012 (JP) 2012-268278

(51) Int. Cl. G06F 3/0482

(52) U.S. Cl. CPC G06F 3/0482
USPC 715/733

(57) ABSTRACT

A vehicle coordinating system includes a mobile electronic device and an in-vehicle electronic device that can be communicatively connected to each other. An in-vehicle calculation section selects, as a mobile-side item, only a function operable by an operation section on a steering wheel from the in-vehicle electronic device among the functions of the mobile electronic device. The in-vehicle calculation section produces a coordinated operation menu by combining the mobile-side item and the items for the functions of the in-vehicle electronic device and displays the coordinated operation menu on an in-vehicle display section in the in-vehicle electronic device so as to allow the coordinated operation menu to be operated by the operation section.

### CROSS REFERENCES TO RELATED APPLICATIONS

The present application claims priority under 35 U.S.C. §119 to Japanese Patent Application No. 2012-268278, filed Dec. 7, 2012, entitled “Vehicle Coordinating System.” The contents of this application are incorporated herein by reference in their entirety.

### TECHNICAL FIELD

The present disclosure relates to a vehicle coordinating system.

### BACKGROUND

There is a vehicle information display apparatus that displays an operation menu having a plurality of operation items in response to an operation by a switch on a steering wheel, selects a specific operation item that has a high possibility for being operated from among the plurality of operation items, and provides guidance for performing a predetermined operation based on the specific operation item (see, for example, Japanese Unexamined Patent Application Publication No. 2008-49816).

### SUMMARY

The above-described vehicle information display apparatus in related art cannot allow an occupant of a vehicle or the like to properly and easily operate the functions of a mobile electronic device (e.g., a cellular phone, a smartphone, a tablet computer) carried by him or her from the vehicle information display apparatus through coordination with the mobile electronic device.

The present application describes a vehicle coordinating system that coordinates a mobile electronic device and an in-vehicle electronic device, that allows a user to properly and easily operate the functions of both devices, and that achieves sufficient operability. In the following explanation of the exemplary embodiment, specific elements with their reference numerals are indicated by using brackets. These specific elements are presented as mere examples in order to facilitate understanding, and thus, should not be interpreted as limiting the accompanying claims.

According to a first aspect of the embodiment, a vehicle coordinating system communicatively connects a mobile electronic device (e.g., mobile electronic device 11 in the embodiment) and an in-vehicle electronic device (e.g., in-vehicle electronic device 13 in the embodiment) and causes the mobile electronic device and the in-vehicle electronic device to function. The vehicle coordinating system includes an operation member (e.g., operation section 15 in the embodiment) disposed on a steering wheel (e.g., steering wheel 14 in the embodiment), an item generating unit (e.g., step S03 in the embodiment) that selects only a function operable by the operation member from the in-vehicle electronic device as a mobile-side item among functions of the mobile electronic device, an operation menu producing unit (e.g., step S04 in the embodiment) that produces an operation menu (e.g., coordinated operation menu in the embodiment) by combining the mobile-side item and items for functions of the in-vehicle electronic device, and a display control unit (e.g., in-vehicle calculation section 34 in the embodiment) that displays the operation menu on a display unit (e.g., in-vehicle display section 33 in the embodiment) in the in-vehicle electronic device such that the operation menu is operable by the operation member.

With the vehicle coordinating system according to the first aspect of the embodiment, the operation menu is produced by adding an item for the function operable or permitted to be operated from the in-vehicle electronic device (mobile-side item) out of the functions of the mobile electronic device to the configuration in which the items for the functions of the in-vehicle electronic device are operable by the operation member on the steering wheel. This enables various functions of the mobile electronic device to be operated from the in-vehicle electronic device. In addition, producing the operation menu by adding the mobile-side item to the items for the functions inherently set in the in-vehicle electronic device enables any new function to be added through the mobile electronic device, while the functions of the in-vehicle electronic device remain active regardless of whether the mobile electronic device is connected or not. Thus versatility of coordination between the in-vehicle electronic device and various mobile electronic devices can be improved. Not enabling all of the functions of the mobile electronic device to be operable from the in-vehicle electronic device but enabling only an item for a specific function (e.g., a function operative with ensured desired safety during the running of the vehicle) to be operable or permitting it to be operated can ensure desired safety.

The vehicle coordinating system according to a second aspect of the embodiment may further include an operation control unit (e.g., also corresponding to the in-vehicle calculation section 34 in the embodiment) that prohibits or restricts operations of the functions by other than the operation member when the operation menu is displayed on the display unit.

With the vehicle coordinating system according to the second aspect of the embodiment, basically using operations by the operation member on the steering wheel with ensured desired safety under the assumption that operations may occur during the running of the vehicle enables various functions of the mobile electronic device from being safely operated from the in-vehicle electronic device.

In the vehicle coordinating system according to a third aspect of the embodiment, the display control unit may change at least one of a displayed position and a displayed shape of the operation menu on the display unit in accordance with a position of the steering wheel.

With the vehicle coordinating system according to the third aspect of the embodiment, the displayed position of the operation menu on the displayed screen in the display unit may be a position deviating (displaced) from the center of the displayed screen to a position closer to the steering wheel in accordance with the position of the steering wheel (position on the left side or right side in the vehicle width direction inside the vehicle compartment). This can improve visibility of the operation menu for a driver who operates the operation member on the steering wheel, can reduce the amount of movement of line of sight of the driver necessary for visually identifying the operation menu during the running of the vehicle, and can guide the attention of the driver toward the front in the direction of travel of the vehicle. The displayed shape of the operation menu on the displayed screen in the display unit may be a shape at which the consciousness of the driver is easily directed from the displayed screen toward the position of the steering wheel (e.g., an arrow shape or a triangular shape that points to the position of the steering wheel) in accordance with the position of the steering wheel. This enables the attention of the driver to be guided toward the front in the direction of travel of the vehicle and can ensure increasing running safety.

In the vehicle coordinating system according to a fourth aspect of the embodiment, the display control unit may change at least one of a displayed position and a displayed shape of the operation menu on the display unit in accordance with a shape and a position of the operation member.

With the vehicle coordinating system according to the fourth aspect of the embodiment, the displayed position or displayed shape of the operation menu on the displayed screen in the display unit may be changed in accordance with the position and shape of the operation member (e.g., D-pad or push button) on the steering wheel. This enables desired operations to be easily executed without the necessity of visually identifying both the operation member and the operation menu, and the operability can be improved. Even if the operation member on the steering wheel does not support operations executable by the mobile electronic device (e.g., flicking or dragging on a capacitance-type touch panel) from the structural reasons, the position and shape of the operation member can correspond to the displayed position or the displayed shape of the operation menu such that pseudo operations are enabled. For example, for a function that requires a vertical flick on the touch panel of the mobile electronic device (e.g., menu forwarding), when the operation member includes a D-pad, the items on the operation menu may be vertically arranged on the displayed screen so as to correspond to the vertical operations of the D-pad.

In the vehicle coordinating system according to a fifth aspect of the embodiment, the display control unit may cause a displayed form of an item that does not satisfy a necessary condition at time of an operation by the operation member from among the items on the operation menu and a displayed form of each of the items other than the item to differ from each other.

With the vehicle coordinating system according to the fifth aspect of the embodiment, the driver can easily identify whether there is a function that requires satisfying a predetermined condition corresponding to the state of the vehicle or the like among the functions of the mobile electronic device which are made operable or permitted to be operated from the in-vehicle electronic device and, if it is determined that such a function is present, whether that function is available or not.

### BRIEF DESCRIPTION OF THE DRAWINGS

The advantages of the disclosure will become apparent in the following description taken in conjunction with the following drawings.

FIG. 1 illustrates a configuration of a vehicle coordinating system according to an embodiment.

FIGS. 2A and 2B illustrate an operation section in the vehicle coordinating system according to the embodiment.

FIG. 3 is a flowchart that illustrates actions of the vehicle coordinating system according to the embodiment.

FIGS. 4A to 4E illustrate displayed examples on an in-vehicle display section of an in-vehicle electronic device in the vehicle coordinating system according to the embodiment.

### DETAILED DESCRIPTION

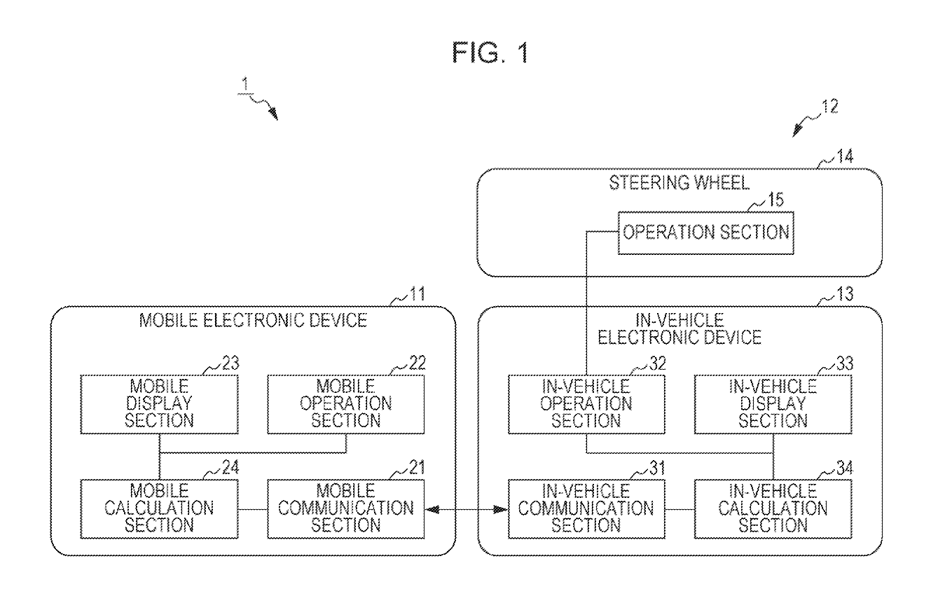

A vehicle coordinating system according to an embodiment is described below with reference to the accompanying drawings. A vehicle coordinating system 1 according to the present embodiment includes a mobile electronic device 11, an in-vehicle electronic device 13 in a vehicle 12, and an operation section 15 disposed on a steering wheel 14 in the vehicle 12, as illustrated in FIG. 1.

The mobile electronic device 11 may be a cellular phone, a smartphone, a tablet computer, or the like and can communicate with the in-vehicle electronic device 13 wirelessly or through wired connection. The mobile electronic device 11 includes a mobile communication section 21, a mobile operation section 22, a mobile display section 23, and a mobile calculation section 24.

The mobile communication section 21 is controlled by the mobile calculation section 24 and exchanges various information with an in-vehicle communication section 31, which is described below, in the in-vehicle electronic device 13 by wired or wireless communication. The mobile operation section 22 is an input device operable with a finger or voice of a user or the like and outputs a signal corresponding to an input operation. The mobile display section 23 is controlled by the mobile calculation section 24 and displays various information thereon.

The mobile operation section 22 and mobile display section 23 may be independent electronic components having the inputting function and the displaying function, respectively, or may be a single electronic component having a combination of the inputting function and the displaying function, such as a capacitance-type touch panel.

The mobile calculation section 24 includes an electronic circuit, such as a central processing unit (CPU). The mobile calculation section 24 performs various calculations on the basis of signals output from the mobile operation section 22 or in-vehicle electronic device 13 or the like and controls the entire action of the mobile electronic device 11.

The in-vehicle electronic device 13 may be a single device having a specific function (e.g., an audio device or a navigation device) or an apparatus having a plurality of functions, such as an assembly of a plurality of devices (e.g., an audio device and a navigation device). The in-vehicle electronic device 13 is operable by the operation section 15 on the steering wheel 14. The in-vehicle electronic device 13 includes the in-vehicle communication section 31, an in-vehicle operation section 32, an in-vehicle display section 33, and an in-vehicle calculation section 34.

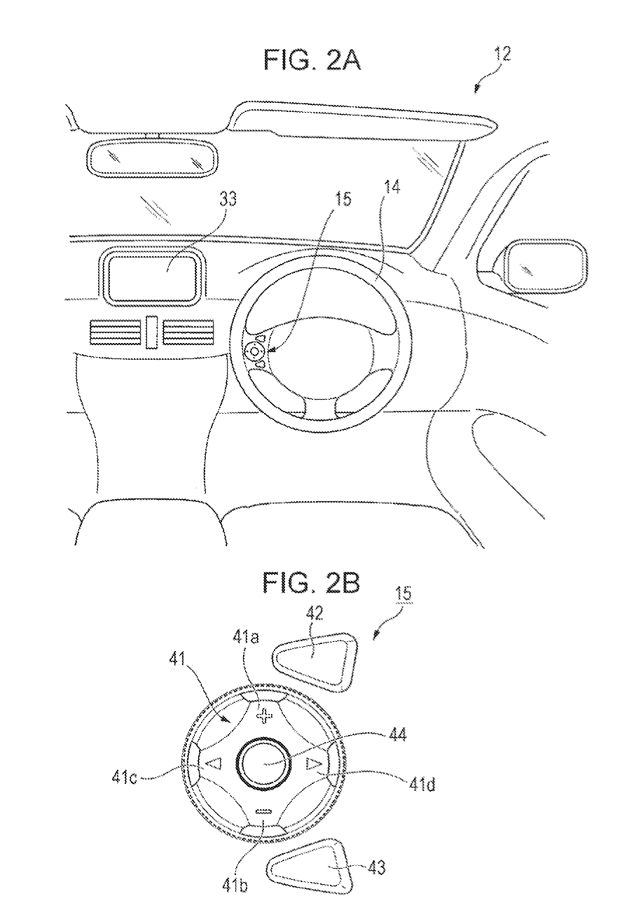

The in-vehicle communication section 31 is controlled by the in-vehicle calculation section 34 and exchanges various information with the mobile communication section 21 in the mobile electronic device 11 by wired or wireless communication. The in-vehicle operation section 32 is an input device operable with a finger or voice of a user or the like and outputs a signal corresponding to an input operation. The in-vehicle operation section 32 is connected to the operation section 15, which is described below, on the steering wheel 14, receives a signal output from the operation section 15, and outputs the received signal. The in-vehicle display section 33 may be arranged in a central portion in the horizontal direction of an instrument panel, as illustrated in FIG. 2A, is controlled by the in-vehicle calculation section 34, and displays various information thereon.

The in-vehicle operation section 32 and in-vehicle display section 33 may be independent electronic components having the inputting function and the displaying function, respectively, or may be a single electronic component having a combination of the inputting function and the displaying function, such as a capacitance-type touch panel.

The in-vehicle calculation section 34 includes an electronic circuit, such as a central processing unit (CPU). The in-vehicle calculation section 34 performs various calculations on the basis of signals output from the in-vehicle operation section 32 or the operation section 15 on the steering wheel 14 or the like and controls the entire action of the in-vehicle electronic device 13.

The operation section 15 on the steering wheel 14 is an input device arranged in a position where it is operable with a finger of a user sitting in the driver's seat. The operation section 15 on the steering wheel 14 may include a D-pad 41 containing four switches that point to four directions of up, down, left, and right and that consist of switches (↑) 41a, (↓) 41b, (←) 41c, and (→) 41d and three push buttons consisting of a first push button (DISP) 42, a second push button (MENU) 43, and a third push button (SOURCE) 44, as illustrated in FIGS. 2A and 2B. The operation section 15 outputs a signal corresponding to an input operation with the finger of the user.

When the mobile electronic device 11 and the in-vehicle electronic device 13 are not communicatively connected to each other, the operation section 15 can operate the functions of the in-vehicle electronic device 13. When the mobile electronic device 11 and the in-vehicle electronic device 13 are communicatively connected to each other, the operation section 15 can operate a predetermined function out of the functions of the mobile electronic device 11, in addition to the functions of the in-vehicle electronic device 13.

The vehicle coordinating system 1 according to the present embodiment has the above-described configuration. Actions of this vehicle coordinating system 1 are described next.

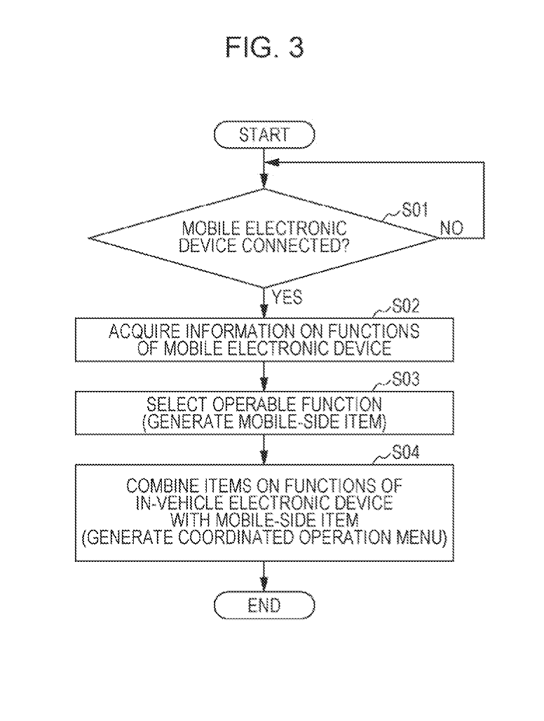

The actions occurring when the mobile electronic device 11 and the in-vehicle electronic device 13 are communicatively connected to each other are described below. First, at step S01 illustrated in FIG. 3, it is determined whether the mobile electronic device 11 and the in-vehicle electronic device 13 are communicatively connected to each other through the mobile communication section 21 and the in-vehicle communication section 31. When the determination is “NO,” the determining process at step S01 is repeated. In contrast, when the determination is “YES,” the processing proceeds to step S02.

At step S02, the in-vehicle calculation section 34 in the in-vehicle electronic device 13 acquires information on the functions of the mobile electronic device 11. At step S02, first, the in-vehicle calculation section 34 outputs a transmission request to transmit information on the functions of the mobile electronic device 11 to the mobile calculation section 24 in the mobile electronic device 11. Then, in response to the transmission request from the in-vehicle calculation section 34, the mobile calculation section 24 transmits information on the functions of the mobile electronic device 11 to the in-vehicle calculation section 34. Then, the in-vehicle calculation section 34 receives the information on the functions of the mobile electronic device 11 from the mobile calculation section 24.

Next, at step S03, when the in-vehicle calculation section 34 receives the information on the functions of the mobile electronic device 11, the in-vehicle calculation section 34 selects only a function operative from the in-vehicle electronic device 13 or a function allowed to be operated from the in-vehicle electronic device 13 out of the functions of the mobile electronic device 11 and generates an item for the selected function as a mobile-side item. Next, at step S04, the in-vehicle calculation section 34 combines the items for the functions of the in-vehicle electronic device 13 (in-vehicle side items) and the mobile-side item such that the mobile-side item is added to the in-vehicle side items and creates a coordinated operation menu including the plurality of items. Then, the processing proceeds to END.

The switches of the operation section 15 on the steering wheel 14 may be associated with the functions described in the following Table 1.

TABLE 1

| SW | Function |
|---|---|
| [DISP] | Call Steering Menu Screen/Switch Function |
| [MENU] | Call Steering Pop-up Screen |
| [SOURCE] | Call Source Flow/Forward Source |
| | Select/Determine Steering Pop-up Screen |
| [↑] [↓] | Increase/Decrease Volume |
| | Move Up and Down List Cursor on Steering |
| | Pop-up Screen |
| [→] [←] | Move Track Forward/Backward |
| | Move Cursor on Source Flow Leftward and |
| | Rightward |
| | Forward/Return Layer in Steering Pop-up |
| | Screen |

The first push button (DISP) 42 outputs, as a signal that requests switching a displayed screen in the in-vehicle display section 33, a signal that requests calling a steering menu screen or a signal that requests switching the function.

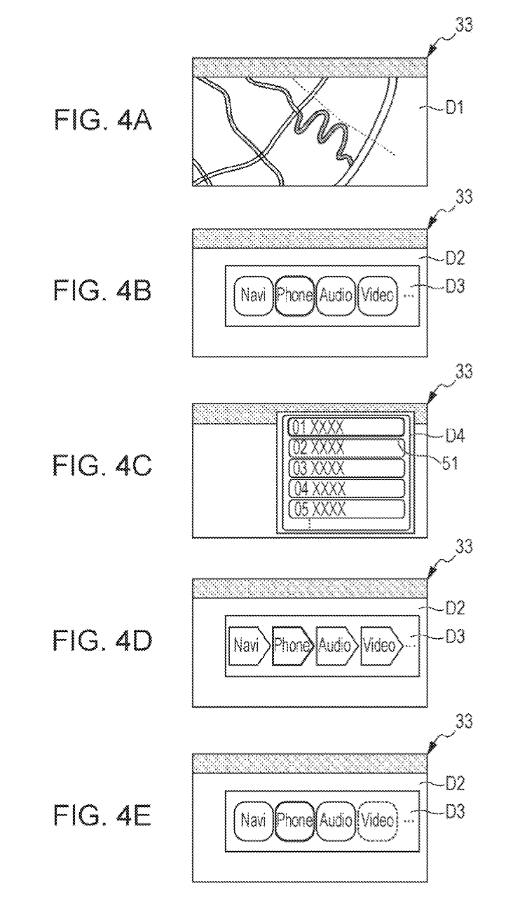

The steering menu screen is a screen in which a steering pop-up screen, which is described below, is displayed at the top, which is the nearest to a user, such that the steering pop-up screen is superimposed on a background screen obtained by darkening an immediately preceding displayed screen (i.e., a displayed screen appearing when the mobile electronic device 11 and the in-vehicle electronic device 13 are not communicatively connected to each other). One example of the steering menu screen is a screen in which the steering pop-up screen (a displayed screen D3 illustrated in FIG. 4B, a displayed screen D4 illustrated in FIG. 4C) is displayed at the top, which is the nearest to a user, such that the steering pop-up screen is superimposed on a background screen D2 illustrated in FIG. 4B obtained by darkening a displayed screen D1 displaying a navigation map illustrated in FIG. 4A.

When the in-vehicle calculation section 34 receives the signal requesting calling the steering menu screen through the in-vehicle operation section 32, as illustrated in FIGS. 4A and 4B, the in-vehicle calculation section 34 darkens a displayed screen appearing on the in-vehicle display section 33 at this time (e.g., the displayed screen D1 displaying the navigation map) and disables operations. Then, the in-vehicle calculation section 34 sets the darkened displayed screen as a background screen (e.g., the background screen D2) and displays the top-layer screen (e.g., the displayed screen D3) of the steering pop-up screen having a hierarchical structure superimposed on the background screen.

When the in-vehicle calculation section 34 receives the signal requesting switching the function through the in-vehicle operation section 32 in a state where the steering menu screen is displayed on the in-vehicle display section 33, the in-vehicle calculation section 34 restores the screen to the state immediately before the steering menu screen is displayed (e.g., the state where the displayed screen D1 displaying the navigation map illustrated in FIG. 4A appears).

The second push button (MENU) 43 outputs, as a signal that requests switching the display on the steering menu screen, a signal that requests calling the top-layer screen (e.g., the displayed screen D3 illustrated in FIG. 4B) in the hierarchical structure of the steering pop-up screen. The steering pop-up screen is a screen in which a coordinated operation menu created by the in-vehicle calculation section 34 is displayed at the top, which is the nearest to a user, on the in-vehicle display section 33 in a pop-up manner.

The top-layer screen in the hierarchical structure of the steering pop-up screen may include the top-layer items “Navi,” “Phone,” “Audio,” and “Video” in the in-vehicle side items and mobile-side items forming the coordinated operation menu and having a hierarchical structure, as illustrated in FIG. 4B. As a lower-layer screen than the top layer in the hierarchical structure of the steering pop-up screen, a lower layer for the item “Phone” may include the items “01XXXX” . . . indicating telephone numbers, as illustrated in FIG. 4C.

The third push button (SOURCE) 44 outputs a signal that requests selecting an item on the steering pop-up screen or determining the selected item.

When the in-vehicle calculation section 34 receives the signal requesting selecting the item on the steering pop-up screen through the in-vehicle operation section 32, the in-vehicle calculation section 34 may sequentially switch an item highlighted (e.g., indicated with thick solid lines) as a selection target item from among the plurality of items forming the steering pop-up screen, as illustrated in FIG. 4B. When the in-vehicle calculation section 34 receives the signal requesting determining the selected item on the steering pop-up screen through the in-vehicle operation section 32, the in-vehicle calculation section 34 determines the item highlighted by a list cursor 51 at this time (e.g., “Phone” item illustrated in FIG. 4B, “01XXXX” item illustrated in FIG. 4C) and starts performing the function corresponding to the determined item.

The two switches (↑) 41a and (↓) 41b in the D-pad 41 output a signal that requests vertical movement of the list cursor 51 capable of highlighting (e.g., indicating with thick solid lines) any item out of a plurality of items that form the steering pop-up screen and that are arranged in the vertical direction of the in-vehicle display section 33. When the in-vehicle calculation section 34 receives the signal requesting vertical movement of the list cursor 51 through the in-vehicle operation section 32, the in-vehicle calculation section 34 may sequentially switch the item highlighted as the selection target out of the plurality of items forming the steering pop-up screen by the vertical movement of the list cursor 51, as illustrated in FIG. 4C.

The two switches (←) 41c and (→) 41d in the D-pad 41 output a signal that requests forwarding or returning the layer in the hierarchical structure of the steering pop-up screen. When the in-vehicle calculation section 34 receives the signal requesting forwarding or returning the layer in the steering pop-up screen through the in-vehicle operation section 32, the in-vehicle calculation section 34 forwards or returns the layer in hierarchical structure of the steering pop-up screen.

The third push button (SOURCE) 44 can be used to output a signal that requests calling a source flow or forwarding the source. Calling the source flow may be calling a procedure of each of the plurality of functions of the in-vehicle electronic device 13. Forwarding the source may be sequentially switching between selecting the procedure of each of the plurality of functions of the in-vehicle electronic device 13 and determining the section.

The two switches (↑) 41a and (↓) 41b in the D-pad 41 output a signal that requests increasing or decreasing the volume of sound of the in-vehicle electronic device 13. The two switches (←) 41c and (→) 41d in the D-pad 41 can output a signal that requests moving a track for play forward or backward or a signal that requests a cursor operation in the source flow. The cursor operation in the source flow may be moving the cursor for highlighting a procedure that is a selection target from among the procedures of the plurality of functions of the in-vehicle electronic device 13 in the horizontal direction of the in-vehicle display section 33 in which the procedures of the plurality of functions are arranged.

When the steering menu screen is displayed on the in-vehicle display section 33, the in-vehicle calculation section 34 prohibits or restricts the operations of the functions of the mobile electronic device 11 from other than the operation section 15 on the steering wheel 14.

For example, when the steering menu screen is displayed in a predetermined state, such as the state where the vehicle 12 is running, the in-vehicle calculation section 34 may prohibit all of the functions of the mobile electronic device 11 from being operated by the mobile operation section 22 or restricts operations of the functions other than a predetermined function. In other than the predetermined state, for example, during the halting of the vehicle 12, the in-vehicle calculation section 34 may permit all of the functions of the mobile electronic device 11 to be operated by other than the operation section 15, regardless of whether the steering menu screen is displayed or not. The predetermined function is a function operable within the range where the vehicle 12 can run properly.

When the steering menu screen is displayed on the in-vehicle display section 33, the in-vehicle calculation section 34 changes at least one of the displayed position and the displayed shape of the steering pop-up screen in accordance with the position of the steering wheel 14.

In the case of the right-hand drive vehicle 12 with the steering wheel 14 on the right side in the vehicle width direction of the vehicle body, the in-vehicle calculation section 34 may display the steering pop-up screen in a position on the right side in the vehicle width direction on the in-vehicle display section 33 (i.e., a side nearer to the driver's seat and the driver), as illustrated in FIGS. 4B and 4C.

In the case of the right-hand drive vehicle 12 with the steering wheel 14 on the right side in the vehicle width direction of the vehicle body, the in-vehicle calculation section 34 may use a shape that points to the right, which is the side of the steering wheel 14, such as an arrow shape or a triangular shape, as the displayed shape of each of the plurality of items forming the steering pop-up screen, as illustrated in FIG. 4D.

The in-vehicle calculation section 34 changes at least one of the displayed position and the displayed shape of the steering pop-up screen in accordance with the shape and position of the operation section 15 on the steering wheel 14.

The in-vehicle calculation section 34 may display a plurality of items forming the steering pop-up screen (e.g., items of “01XXXX” . . . , which indicate telephone numbers) such that they are aligned in the vertical direction of the in-vehicle display section 33 so as to correspond to the two switches (↑) 41a and (↓) 41b in the operation section 15 equipped with the D-pad 41, as illustrated in FIG. 4C. The in-vehicle calculation section 34 may display a plurality of items forming the steering pop-up screen such that they are aligned in the horizontal direction of the in-vehicle display section 33 so as to correspond to the two switches (←) 41c and (→) 41d in the D-pad 41.

Even when the operation section 15 on the steering wheel 14 does not support operations executable by the mobile electronic device 11 (e.g., flicking or dragging on a capacitance-type touch panel), the in-vehicle calculation section 34 associates the position and shape of the operation section 15 with the displayed position or the displayed shape of the steering pop-up screen such that pseudo operations are enabled. For example, the in-vehicle calculation section 34 may display a plurality of items forming the steering pop-up screen such that they are aligned in the vertical direction of the in-vehicle display section 33 and are associated with vertical operation of the two switches (↑) 41a and (↓) 41b in the D-pad 41 in the operation section 15 with respect to a function that requires a vertical flick on the mobile display section 23 including a capacitance-type touch panel in the mobile electronic device 11 (e.g., menu forwarding).

The in-vehicle calculation section 34 causes an item that does not satisfy a necessary condition at the time of an operation by the operation section 15 on the steering wheel 14 out of the plurality of items forming the steering pop-up screen to be displayed in a different form than the other items. Examples of the necessary condition at the time of the operation by the operation section 15 may be the presence/absence of a predetermined state of the vehicle 12, such as whether the vehicle 12 halts or not or whether the vehicle 12 is running at below a predetermined speed.

During the running of the vehicle 12, the in-vehicle calculation section 34 may indicate the item “Video,” which is permitted to be operated only during the halt of the vehicle, with the dotted lines from among the plurality of items forming the steering pop-up screen and indicate the other items permitted to be operated regardless of whether the vehicle 12 is running or not with the solid lines, as illustrated in FIG. 4E.

As described above, with the vehicle coordinating system 1 according to the present embodiment, a function of the mobile electronic device 11 is operably added to the configuration in which the functions of the in-vehicle electronic device 13 are operable by the operation section 15 on the steering wheel 14. Thus, various functions of the mobile electronic device 11 can be easily operated from the in-vehicle electronic device 13. In addition, any new function can be added through the mobile electronic device 11 even after shipment, while the functions of the in-vehicle electronic device 13 remain available regardless of whether the mobile electronic device 11 is connected or not. This can improve versatility of coordination between the in-vehicle electronic device 13 and various types of the mobile electronic devices 11, can appropriately support evolution and increasing variety of the mobile electronic devices 11, and can enhance convenience.

The coordinated operation menu is created such that not all of the functions of the mobile electronic device 11 are operable from the in-vehicle electronic device 13 and only a specific function is operable or permitted to be operated. This can ensure desired safety of the vehicle 12. In addition, prohibiting or restricting operations of the functions from other than the operation section 15 when the steering menu screen is displayed on the in-vehicle display section 33 and basically permitting only operations by the operation section 15 with ensured desired safety under the assumption that operations may occur during the running of the vehicle enables various functions of the mobile electronic device 11 to be safely operated from the in-vehicle electronic device 13.

In addition, visibility of the steering pop-up screen for a driver who operates the operation section 15 can be improved, the amount of movement of line of sight of the driver necessary for visually identifying the steering pop-up screen during the running of the vehicle can be reduced, the attention of the driver can be guided toward the front in the direction of travel of the vehicle 12, and increasing running safety can be ensured.

Moreover, the desired operations can be easily and intuitively executed without the necessity of visually identifying both the operation section 15 and the steering pop-up screen, and operability can be improved. Even when the operation section 15 does not support operations executable by the mobile electronic device 11, associating the position and shape of the operation section 15 with the displayed position or displayed shape of the steering pop-up screen such that pseudo operations are enabled can ensure convenience.

Furthermore, the driver can easily identify whether there is a function that requires satisfying a predetermined condition corresponding to the state of the vehicle 12 among the functions of the mobile electronic device 11 operable or permitted to be operated from the in-vehicle electronic device 13 and, if it is determined that such a function is present, whether that function is available or not.

In the above-described embodiment, the in-vehicle calculation section 34 prohibits or restricts the operations of the mobile electronic device 11 by other than the operation section 15 when the steering menu screen is displayed in a predetermined state, such as the state where the vehicle 12 is running. The present application is not limited to this embodiment. For example, when the steering menu screen is displayed, regardless of the predetermined state, such as whether the vehicle 12 is running or not, the operations of the functions of the mobile electronic device 11 by other than the operation section 15 may be prohibited or restricted.

The technical scope of the present application is not limited to the above-described embodiment, rather encompasses various changes without departing from the spirit of the present application. That is, the above-described embodiment is illustrative only, and changes may be made.

We claim:

1. A vehicle coordinating apparatus that communicatively connects a mobile electronic device to an in-vehicle electronic device and that causes the mobile electronic device and the in-vehicle electronic device to function cooperatively, the vehicle coordinating system comprising:
an operation member disposed on a steering wheel;
an item generating unit that selects and itemizes, among functions of the mobile electronic device, only a function operable by the operation member from the in-vehicle electronic device as a mobile-side item;
an operation menu producing unit that produces an operation menu by combining the mobile-side item and items of functions of the in-vehicle electronic device; and
a display control unit that displays the operation menu on a display unit in the in-vehicle electronic device such that the operation menu is operable by the operation member.

2. The vehicle coordinating system according to claim 1, further comprising an operation control unit that prohibits or restricts the functions of the mobile electronic device of the mobile-side item from being operated by other than the operation member when the operation menu is displayed on the display unit.

3. The vehicle coordinating system according to claim 1, wherein the display control unit changes at least one of a displayed position and a displayed shape of the operation menu on the display unit in accordance with a position of the steering wheel.

4. The vehicle coordinating system according to claim 1, wherein the display control unit changes at least one of a displayed position and a displayed shape of the operation menu on the display unit in accordance with a shape and a position of the operation member.

5. The vehicle coordinating system according to claim 1, wherein the display control unit controls the displayed operation menu such that an item included in the operation menu and not satisfying a necessary condition at a time of an operation by the operation member is displayed in a different form than the other items on the operation menu.

6. A method comprising:
communicatively connecting a mobile electronic device to an in-vehicle electronic device to cause the mobile electronic device and the in-vehicle electronic device to function cooperatively;
selecting and itemizing, among functions of the mobile electronic device, only a function operable by an operation member from the in-vehicle electronic device as a mobile-side item, the operation member being disposed on a steering wheel;
producing an operation menu by combining the mobile-side item and items of functions of the in-vehicle electronic device; and
displaying the operation menu on a display unit in the in-vehicle electronic device such that the operation menu is operable by the operation member.
